(19) United States
(12) Patent Application Publication
(10) Pub. No.: US 2025/0156854 A1
(43) Pub. Date: May 15, 2025

(54) SYSTEM AND METHOD FOR SERIAL DELIVERY OF CONTENT USING NONFUNGIBLE TOKENS

(71) Applicant: ORIGINAL DIGITAL CORPORATION, HOUSTON, TX (US)

(72) Inventors: PAUL ALAN CALDWELL, HOUSTON, TX (US); JOEL BINN, FORT LEE, NJ (US)

(73) Assignee: ORIGINAL DIGITAL CORPORATION, HOUSTON, TX (US)

(21) Appl. No.: 18/509,280

(22) Filed: Nov. 14, 2023

(51) Int. Cl. G06Q 20/36

(52) U.S. Cl. CPC G06Q 20/3678

(57) ABSTRACT

A method and system for digital distribution of content via non-fungible tokens and a blockchain, for example, to distribute digitized artwork along with a story about the artist or the subject of the artwork. The system and methods may be used to create serialized messaging segments within a series to tell a story in unique ways, such as a series of six short segments of media including text, audio or video or a combination thereof. Content may be embedded into or linked in associated with a nonfungible token may be electronically delivered a user. In some embodiments, a user owning all non-fungible tokens in a series is enabled to stitch together all content in the series into a single digital asset. In this case, smart contracts may be employed to auto-create a new non-fungible token for the single digital asset.

### TECHNICAL FIELD

The present disclosure relates generally to systems and methods for serial electronic delivery of artistic content, such as fine art, music, and videos, and other collectables, to consumers using nonfungible tokens.

### BACKGROUND

The use of nonfungible tokens for digital art has recently entered the mainstream, allowing artists and other content providers to be able to sell their art in a way that can sustain them and allowing the buyers of the content to own the content in a verifiable way. Unlike conventional crypto tokens, such as Bitcoin, a nonfungible token has a unique identifier and is not divisible. Each nonfungible token is unique, thereby enabling digital scarcity for unique and traceable items. Scarcity in this context means a limited and controllable supply. For a given content, there could be one, a hundred, or tens of thousands of replica nonfungible tokens created, but each of them would have a unique identification. The creator of a nonfungible token gets to decide the scarcity of their asset.

Nearly any content that can be reduced to and stored digitally can be tokenized. The digitized content is either directly attached to or linked to the token, which is stored on a blockchain.

A blockchain is essentially an electronic ledger. Most blockchains are publicly accessible and transparent, designed to operate without a central controlling authority. In such blockchains, when parties make a transaction, a data block is created that houses the sender's and recipient's addresses as strings of letters and numbers that log a timestamp and the involved parties without revealing their identities. Transactions are authenticated using public and private cryptographic keys that together identify a user and give access to their account or “wallet” of value on the system and create a secure digital identity to authenticate the user to enable a desired transaction.

The transaction is submitted to a mesh network of public computers, referred to as nodes, for authorization. The decision to add a transaction to the chain is generally made by consensus that a majority of the nodes agree that the transaction is valid. Once a transaction is confirmed, the data block is added to the blockchain. The appended blocks form a digital blockchain as transactions continue, and the blocks cannot be edited. Any hacking attempt would be immediately flagged as invalid by the numerous nodes comprising the mesh network.

Operators of nodes in the blockchain network are incentivized, typically by earning a form of cryptocurrency, to verify transactions through rewards in a process known as proof of work or mining. Proof of work typically requires solving a complex mathematical problem to be able to add a block to the chain. However, some blockchain networks have adopted proof of stake validation consensus protocols, where participants must have a stake in the blockchain, usually by owning some of the cryptocurrency, to validate transactions.

Many blockchain topologies exist. Some blockchain technologies, such as Ethereum, provide for smart contracts, which automatically execute transactions when certain conditions have been met. Smart contracts are simply programs stored on a blockchain that run when predetermined conditions are met. They typically are used to automate the execution of an agreement so that all participants to a transaction can be immediately certain of the outcome, without any intermediary's involvement or time loss. They can also automate a workflow, triggering a following action when conditions are met.

Smart contracts work by following simple “if/when . . . then . . . ” statements that are written into code on a blockchain. The blockchain nodes execute the actions when predetermined conditions have been met and verified. These actions may include releasing funds to the appropriate parties, sending notifications, or providing content, for example. The blockchain is then updated with a new block when the transaction is completed. As with all blocks in a blockchain, transaction cannot be changed, and only parties who have been granted permission can see the results.

As with a conventional legal contract, within a smart contract, there can be as many stipulations as needed to satisfy the participants that the task will be completed satisfactorily. To establish the terms, participants must determine how transactions and their data are represented on the blockchain and agree on the “if/when . . . then . . . ” rules that govern those transactions. Well drafted smart contracts explore all possible exceptions and define a framework for resolving disputes.

Returning now to the discussion of nonfungible tokens, digitized artistic and/or collectable content may be stored associated with the blockchain in different ways: The digitized content may be integrally created as part of the nonfungible token and stored directly on the blockchain; or, the digitized content may be linked to a nonfungible token and stored as a tokenized block on a different blockchain or as one or more files on one or more centralized or decentralized servers.

Nonfungible tokens are created in a process referred to as minting, through smart contracts that assign ownership and manage the transferability of the tokens. When someone creates or mints a nonfungible token, they execute code stored in smart contracts that conform to one or more particular blockchain standards, such as ERC-721. This information is added to the blockchain where the token is being managed. The minting process includes the following steps: Creating a new block, validating information, and recording information onto the blockchain. As the nonfungible token changes hands through sales, additional blocks are added to the blockchain to document the ownership. For example, when one purchases a nonfungible token, the ownership of the unique token is transferred to the purchaser's wallet via his or her public address. The token proves that the purchaser's copy of the digital file is the original. The purchaser's private key is proof-of-ownership of the original, and the content creator's public key serves as a certificate of authenticity for that particular digital artefact. The creator's public key becomes a permanent part of the token's history, demonstrating that the purchased token was created by a particular individual.

Artistic content and collectables have to date been tokenized and sold to consumers only in an ad hoc fashion. For example, various musicians have released music via nonfungible tokens, and digital artwork nonfungible tokens have been sold at auction. In most cases, purchasers do not own the underlying work itself or the original digital file, meaning the content can still be seen and shared online. Instead, the token represents ownership of a controlled digital copy of the underlying work. The nonfungible token is perhaps best described as a sort of digital certificate of authenticity, and for some it has become a desirable collectible. In most cases, a nonfungible token can be resold, and the blockchain may provide for a continued revenue stream through resale for the producer of the underlying content.

Despite the recent ad hoc introduction of nonfungible tokens into the marketplace, a system and method for distributing a collection of related content in a serial manner is desirable. There is further a need for a system and method that entices purchasers to buy an entire series of nonfungible tokens.

### BRIEF DESCRIPTION OF THE DRAWINGS

Many aspects of the present disclosure can be better understood with reference to the following drawings, in which:

FIG. 1 is a block diagram of a system and method for minting nonfungible tokens for serial distribution of content according to one or more embodiments;

FIG. 2 is a block diagram of a system and method for distributing a nonfungible token minted in accordance with the system and method of FIG. 1, according to one or more embodiments; and

FIG. 3 is a block diagram of a system and method for distributing a series of related nonfungible tokens according to one or more embodiments.

The components in the drawings are not necessarily to scale, with emphasis instead being placed upon clearly illustrating the principles of the disclosure. Moreover, in the drawings, like reference numerals designate corresponding parts throughout the several views.

### DETAILED DESCRIPTION

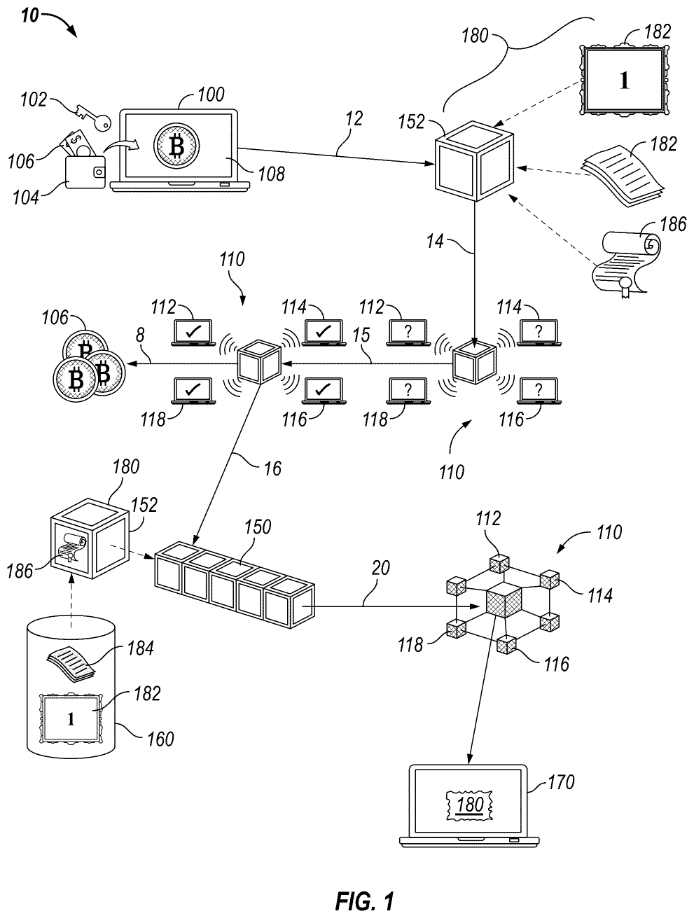

FIG. 1 is a block diagram that illustrates a method 10 for minting nonfungible tokens for serial distribution of content according to one or more embodiments. Referring to FIG. 1, the system includes a computer 100 for operation by a minter. Computer 100 ideally includes a private cryptographic key 102, an electronic wallet 104 adapted for storing a cryptocurrency 106, and appropriate software 108 for interacting with a blockchain node network 110. The system further includes blockchain node network 110, which ideally is comprised of a large number of decentralized computing nodes 112, 114, 116, 118 that cooperate to maintain a blockchain 150, validate transactions, and append blocks 152 representing the validated transactions to blockchain 150. The system also includes an auction or sales outlet 170, which may be a web server accessible to the public via the internet through which interested persons may shop for and purchase the minted nonfungible tokens. Finally, the system may include one or more databases or database servers 160, which may be centralized or decentralized.

At step 12, using computer 100, the minter creates a nonfungible token 180, which in one or more embodiments may include a digitized artwork or collectable 182, a short story 184 that pertains to the subject of the artwork or collectable 182, and a smart contract 186. The artwork or collectable 182 may include images of an original piece of fine art, a meme, a music recording, or anything else that may be reduced to a digital form, as known in the art. The short story 184 may provide details about the subject of the artwork or collectable 182 or about the artist who produced the artwork or collectable 182, for example. It may be provided as a text file, a pdf file, an audio recording, a video short, or in any other multimedia format as known in the art. The smart contract 186 may allow the token 180 to be resold on one or more secondary markets and provide for continued royalties to be paid to the minter, the artist who produced the artwork or collectable 182, the author of short story 184, a charitable foundation, other interested parties, or any combination thereof.

At step 14, the nonfungible token 180 is submitted to blockchain node network 110 for authentication. As described above, the step 15 of authenticating requires a majority consensus of mining nodes 112, 114, 116, and 118 that agree the transaction is valid. Once nonfungible token 180 is authenticated, at step 16, nonfungible token 180 is appended to blockchain 150. Concurrently, at step 18, mining nodes 112, 114, 116, and 118 that participated in the authentication process are paid, typically in cryptocurrency 106.

FIG. 1 illustrates that the artwork or collectable 182 and the short story 184 are stored off blockchain 150 in database 160 and are linked to token 180, while the smart contract 186 is included in the token. However, in one or more embodiments, the artwork or collectable 182 and the short story 184 may also be integrally included within the blockchain block 152. In other embodiments still, the short story 184 may be included with token 180 and stored on the blockchain, while the artwork or collectable 182 remains stored off the blockchain. The choice of whether to store artwork or collectable 182 and the short story 184 off-chain or on-chain depends on the size of the digital files, the capabilities of the blockchain 150, the various allowable token protocols, and the costs involved.

The update of appending nonfungible token 180 to blockchain 150 is distributed across the blockchain node network 110 at step 20. At step 22, nonfungible token 180 is offered for sale or at auction via outlet 170.

As noted above, the minter gets to decide the scarcity of the tokenized content by determining the number of replica nonfungible tokens 180 minted. Say, for example, the nonfungible token 180 includes digitized artwork 182 featuring the numeral “1”, as illustrated, and the minter wishes to mint a hundred replica nonfungible tokens 180 with this artwork. The process 10 of FIG. 1 is then repeated one hundred times, thereby creating one hundred replica nonfungible tokens, each with artwork 182 featuring the numeral “1”, and each creating a new block 152 on blockchain 150. In other embodiments, one or more batch processes may be used to simplify the minting process. However, some blockchain systems, either extant or yet to be developed, may allow multiple replica nonfungible tokens to be created using a single block transaction, and such functionality falls within the scope of this disclosure.

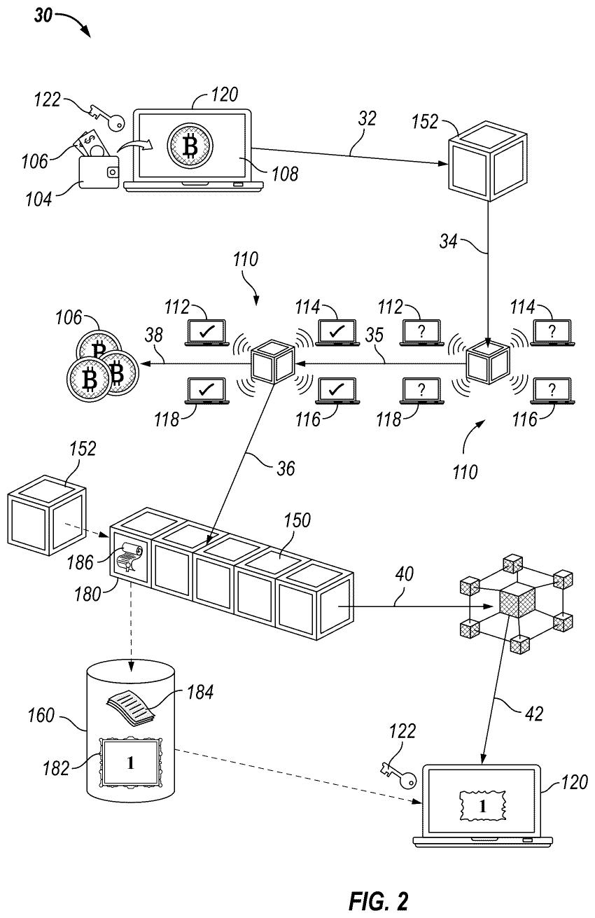

FIG. 2 is a block diagram of a system and method 30 for distributing a nonfungible token minted in accordance with the system and method of FIG. 1 according to one or more embodiments. Referring to FIG. 2, the system generally includes the system components of FIG. 1, and further includes a computer 120 used by a purchaser of a nonfungible token. Computer 120 ideally includes a private cryptographic key 122, an electronic wallet 104 adapted for storing a cryptocurrency 106, and appropriate software 108 for interacting with a blockchain node network 110.

In method 30, the purchaser interacts with outlet 170 (FIG. 1) and completes a purchase of nonfungible token 180 using computer 30. At step 32, a block 152 representing the transaction is created, and at step 34, the transaction is promulgated to the blockchain node network 110 for authentication. As described above, the step 35 of authenticating requires a majority consensus of mining nodes 112, 114, 116, and 118 that agree the transaction is valid. Once the transaction is authenticated, at step 36, block 152, documenting the transaction, is appended to blockchain 150. Concurrently, smart contract 186 in nonfungible token 180 is executed, and any applicable royalty payments or other provisions are carried out. Further, at step 38, mining nodes 112, 114, 116, and 118 that participated in the authentication process are paid, typically in cryptocurrency 106. The update of appending block 152 to blockchain 150 is distributed across the blockchain node network 110 at step 40.

At step 42, the purchaser is able to access block chain 150 on computer 120, and with private cryptographic key 122, access artwork or collectable 182 and short story 184. In one or more embodiments, the digital files for artwork or collectable 182 and short story 184 are encrypted and require a special software environment on computer 120 and private cryptographic key 122 to be accessed. The method of FIG. 2 is repeated for each purchaser of a nonfungible token 180.

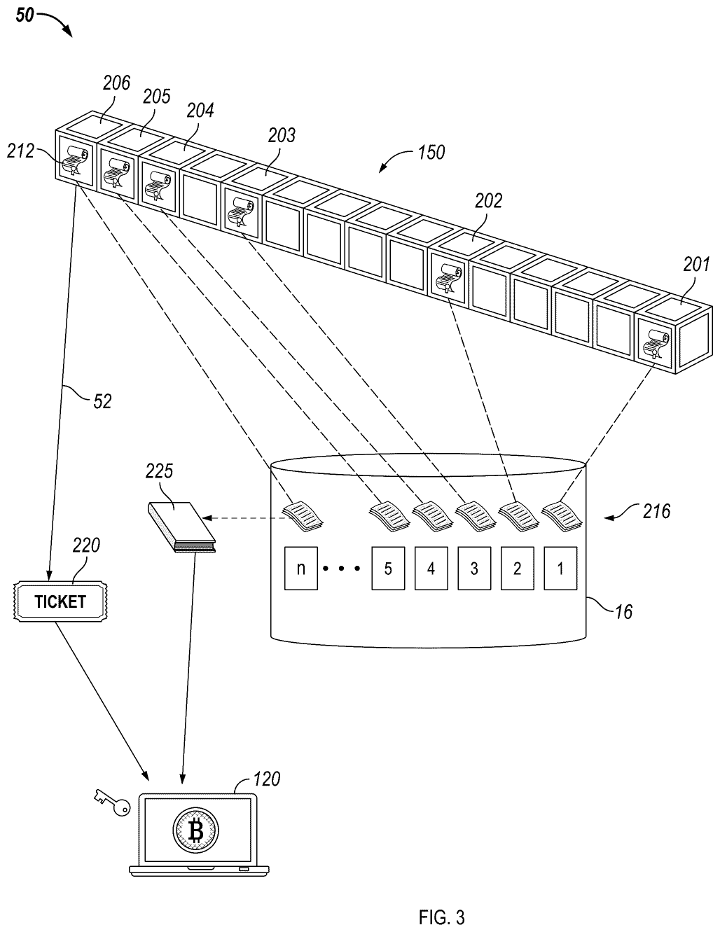

FIG. 3 is a block diagram of a system and method 50 for distributing a series of nonfungible tokens according to one or more embodiments. Referring to FIG. 3, in preferred embodiments, the minter may have a series of related content to distribute. For example, in FIG. 3, digitized artwork of a series of numerals 1, 2, 3, . . . n and short stories, each detailing something noteworthy about the corresponding numeral, are minted as nonfungible tokens 201, 202, 203, 204, 205, 206 on blockchain 150. In the example of FIG. 3, the artwork and short story files are stored off-chain in database 160 and are linked to the tokens on the blockchain, although on-chain storage falls within the scope of this disclosure.

Only one nonfungible token 201, 202, 203, 204, 205, 206 of each of the related series is illustrated on blockchain 150 for brevity. However, in practice, a limited set of replica nonfungible tokens for each of the series may be minted. The first set of nonfungible tokens 201 may be released for sale or auction on a given day. A period of time later, such as a week or a month, the second set of nonfungible tokens 202 is released for sale or auction, and so on until the final set of nonfungible tokens 206 is released.

As shown in FIG. 3, upon purchase of a nonfungible token 206 belonging to the final set, its smart contract 212 is executed. At the time of execution of smart contract 212 and provided a predetermined expiration date has not occurred, if the purchaser owns all the nonfungible tokens 201, 202, 203, 204, 205, 206 within the series, whether by purchase via outlet 170 or by a secondary market, as documented and verified by blockchain 150, at step 51 the token may issue a ticket 220 to the purchaser. The ticket may be used for a myriad of purposes, such as an auction for a physical artwork related to the series, a red carpet event, or the like.

However, as each nonfungible token 201, 202, 203, 204, 205, 206 contains a smart contract, ticket 220 may be issued by any nonfungible token within the series, thereby allowing a purchaser to obtain the ticket 220 even if one or more of the token is purchased out of order.

Additionally, the smart contracts may be used, if a purchaser owns each nonfungible token within a series, to stitch together all of the short stories 216 of the series into a complete work 225. In one or more embodiments, the complete work 225 may include more material than is provided collectively by all of the short stories 216.

The system and methods of FIGS. 1-3 may be used, for example, to distribute digitized artwork along with a story about the artist or the subject of the artwork. In other embodiments, the system and methods of FIGS. 1-3 may be used to create serialized messaging segments within a series to tell a story in unique ways using nonfungible tokens. For example, a series of six short segments of media including text, audio or video or a combination thereof, for example five minutes in duration and embedded into a nonfungible token may be electronically delivered a user. This series of five minutes segments can be stitched together or combined to create a thirty minute text E-book, MP3 based audiobook or video file such as animated cartoons and so forth. A first series of six five-minute nonfungible tokens may form Series 1, Episode 1 of a show; a second series of six five-minute nonfungible tokens may form Series 1, Episode 2, and so on. The combinations are limitless. The end result is a show that is secured with nonfungible tokens and delivered electronically in the form of animated cartoons movies, audiobooks, digital textbooks, et cetera. This method has the advantage of allowing for on-chain storage of the digitized content because of smaller file size, ensuring safekeeping thereof, while allowing the smaller content segments of multiple nonfungible tokens to be reconstituted into a feature-length program. In still another embodiment, when stitching together the segments within a series of NFTs, a new NFT that contains the entire series as a single digital asset, can be automatically created by the smart contract and added to the blockchain.

Algorand is a block chain technology that particularly lends itself to implementing the various embodiments disclosed herein.

It will be understood from the foregoing description that modifications and changes may be made in various embodiments of the present invention without departing from its true spirit. The descriptions in this specification are for purposes of illustration only and are not to be construed in a limiting sense.

The Abstract of the disclosure is solely for providing the a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the invention.

What is claimed is:

1. A method for serial digital delivery of content comprising:
minting a first non-fungible token;
linking a first media segment to said first non-fungible token;
minting a second non-fungible token; and
linking a second media segment to said second non-fungible token, wherein said second media segment is a continuation of said first media segment.

2. The method of claim 1 wherein:
said first non-fungible token includes a first smart contract;
said second non-fungible token includes a second smart contract; and
said first and second smart contracts are structured so that when said first and second non-fungible tokens are owned in a common wallet, said second media segment may be appended to said first media segment to form single combined digital asset.

3. The method of claim 2 further comprising:
minting initiated by said first and second smart contracts a new non-fungible token, said single combined digital asset linked to said new non-fungible token.

4. The method of claim 1 wherein:
said first non-fungible token denotes ownership of a first digital asset; and
said first media segment is associated with said first digital asset.

5. A method for serial digital delivery of content consisting of a series of episodes, the method comprising:
minting a plurality of non-fungible tokens
linking each of said plurality of non-fungible tokens with one episode of the series; and
disseminating said plurality of non-fungible tokens via a blockchain.
